(19) United States
(12) Patent Application Publication
(10) Pub. No.: US 2015/0259979 A1
(43) Pub. Date: Sep. 17, 2015

(54) Ladder and Storage Rack Maintenance Facility Including the Same

(71) Applicant: Daifuku Co., Ltd., Osaka-shi (JP)

(72) Inventors: Takeshi Abe, Higashiomi-shi (JP); Shinsuke Kawamura, Ritto-shi (JP)

(21) Appl. No.: 14/641,772

(22) Filed: Mar. 9, 2015

(30) Foreign Application Priority Data
Mar. 11, 2014 (JP) 2014-047451

(51) Int. Cl. E06C 1/04; A47B 87/00; A47B 96/00

(52) U.S. Cl. CPC E06C 1/04; A47B 96/00; A47B 87/007

(57) ABSTRACT

A ladder includes a pair of protruding portions protruding outwardly on opposite sides in the direction of alignment of the longitudinal bars at the upper end of the longitudinal bars. Structures are provided with a pair of placement support portions spaced apart by a set distance that is longer than the distance between the outer side surfaces of upper end portions of the longitudinal bars in a direction of alignment thereof. The amount of protrusion of the protruding portions is such that the protruding portions overlap in plan view with the placement support portions located at the respective corresponding positions when the ladder is oriented such that a direction of alignment of the upper end portions of the longitudinal bars coincides with the direction of alignment of the placement support portions.

### CROSS-REFERENCE TO RELATED APPLICATION

This application claims priority to Japanese Patent Application No. 2014-047451 filed Mar. 11, 2014, the disclosure of which is hereby incorporated in its entirety by reference.

### FIELD OF THE INVENTION

The present invention relates to a ladder and a storage rack maintenance facility including the same.

### BACKGROUND

In the case of installing a ladder across a narrow space interposed between a pair of structures, it is conceivable to install the ladder by resting the ladder against one of the pair of structures. For example, it is possible to reliably install the ladder by providing engaging hooks at the upper end of the ladder and engaged portions for being engaged with the engaging hooks at the structure at positions at a predetermined height, and causing the engaging hooks to catch the engaged portions. However, with such an installation method in which the ladder is rested against one of the pair of structures, the space between a ladder rested against a structure and the structure, and the space between the structure and a structure facing therewith are restricted by an amount of the space required to rest the ladder. Therefore, it is difficult to secure a sufficient space behind an operator who is directly facing the ladder. In particular, when the ladder is rested against the structure in an inclined manner, the operator's ascending and descending may be more difficult at the lower end side of the ladder. For this reason, it is conceivable to use, for example, a ladder that can be placed in any direction, as disclosed in JP 2003-105967.

This ladder includes return-biased engaging pins at its upper end portion. When this ladder is installed across an installation space, the operator first pulls the engaging pins to retract the tips of the engaging pins. Next, in this state, the operator aligns engaging holes provided in a structure for which the ladder is to be installed and the engaging pins provided at the upper end of the ladder, and thereafter, causes the engaging pins to return to the protruding state. Consequently, the upper end of the ladder can be fixed at the positions of the engaging holes. For example, by providing the engaging holes in each of a pair of structures at a location where the pair of structures face each other, it is possible to install the ladder in a state in which it is supported by the two structures. In other words, it is possible to install the ladder in a state in which the operator is capable of ascending and descending the ladder while directly facing a direction along the longitudinal direction of the installation space interposed between the pair of structures.

However, with this configuration, the operator has to pull and retract the engaging pins, and cause the engaging pins to return to the protruding state at positions at which the engaging pins and the engaging holes overlap with each other, and therefore, the operation of installing the ladder is complicated. In addition, when the ladder is installed for an operation performed at a location at a large height from the floor surface, the engaging holes are provided at a high place, making the ladder installation operation difficult.

### SUMMARY OF THE INVENTION

Therefore, there is a need for a ladder that allows the operator to readily ascend and descend even when placed in a narrow installation space and is also easy to install, and a storage rack maintenance facility including such a ladder.

A preferred aspect of the present invention provides a ladder configured to be portable to be installed across an installation space formed between a pair of structures, the ladder including:

a pair of longitudinal bars;

a plurality of lateral bars spanning between the pair of longitudinal bars, the lateral bars being provided so as to be spaced apart from each other along a longitudinal direction of the longitudinal bars; and

a pair of protruding portions, the protruding portions protruding outwardly on opposite sides in a direction of alignment of the pair of longitudinal bars at an upper end of the pair of longitudinal bars,

wherein the pair of structures are provided with a pair of placement support portions that are spaced apart by a set distance that is longer than a distance between outer side surface of upper end portions of the pair of longitudinal bars in the direction of alignment,

an amount of protrusion of the protruding portions is set such that the pair of protruding portions overlap in plan view with the placement support portions located at respective corresponding positions when the ladder is oriented such that a direction of alignment of the upper end portions of the longitudinal bars coincides with a direction of alignment of the pair of placement support portions, and

the ladder is configured to be installed across the installation space by the pair of placement support portions receiving and supporting respective corresponding ones of the pair of protruding portions from below. Note that “plan view” refers to a state viewed in a direction along the vertical direction. In addition, the expression “overlap in plan view” includes an at least partially overlapping state.

With this configuration, after carrying the ladder from the outside of the installation space into the installation space, the operator can install the ladder across the installation space by a simple operation of positioning the upper end of the ladder above the placement support portions provided at the respective corresponding ones of the pair of structures while supporting the lower end of the ladder, and lowering the ladder in a state in which the pair of protruding portions overlap in plan view with the placement support portions located at the respective corresponding positions. Then, the direction of alignment of the upper end portions of the longitudinal bars (i.e., the longitudinal direction of the lateral bars) of the ladder installed in the above-described manner coincides with the direction of alignment of the pair of placement support portions. Accordingly, the operator can ascend and descend the ladder in an orientation in which the operator is directly facing a direction along the longitudinal direction of the narrow installation space.

With an installation method in which the ladder is rested against one of the pair of structures, the space in which the ladder and the operator who ascends and descends the ladder are located is interposed between the pair of structures. Usually, the installation space formed between the pair of structures is narrow, and therefore, the space formed behind the operator when the operator is directly facing the ladder is restricted. In particular, when the ladder is installed so as to be inclined to the structure, it is difficult to secure a sufficient space behind the operator at the lower end of the ladder, making the operator's ascending and descending difficult. In contrast, the ladder having the above-described configuration is installed across the installation space in a state in which the direction of alignment of the longitudinal bars extends along the direction of alignment of the pair of structures, and therefore, there is no structure behind the operator even if the operator is directly facing the ladder. Accordingly, it is possible to secure a sufficient space behind the operator, facilitating the operator's ascending and descending. Thus, with the above-described configuration, it is possible to provide a ladder that allows the operator to readily ascend and descend even when placed in the narrow installation space, and that is also easy to install.

Further features and advantages of the present invention will become apparent from the following description of embodiments of the invention with reference to the drawings.

### BRIEF DESCRIPTION OF THE DRAWINGS

FIG. 1 is a side view of a semiconductor substrate container warehouse in which a ladder is placed.

FIG. 2 is a diagram showing a state in which the ladder and footboards are placed on horizontal members.

FIG. 3 is a side view showing the structure of an upper end portion of the ladder.

FIG. 4 is a front view showing the structure of the upper end portion of the ladder.

FIG. 5 is a diagram illustrating a method for installing the ladder.

FIG. 6 is a diagram illustrating a relationship between a top surface of a flat portion and footboards of the ladder.

### DETAILED DESCRIPTION

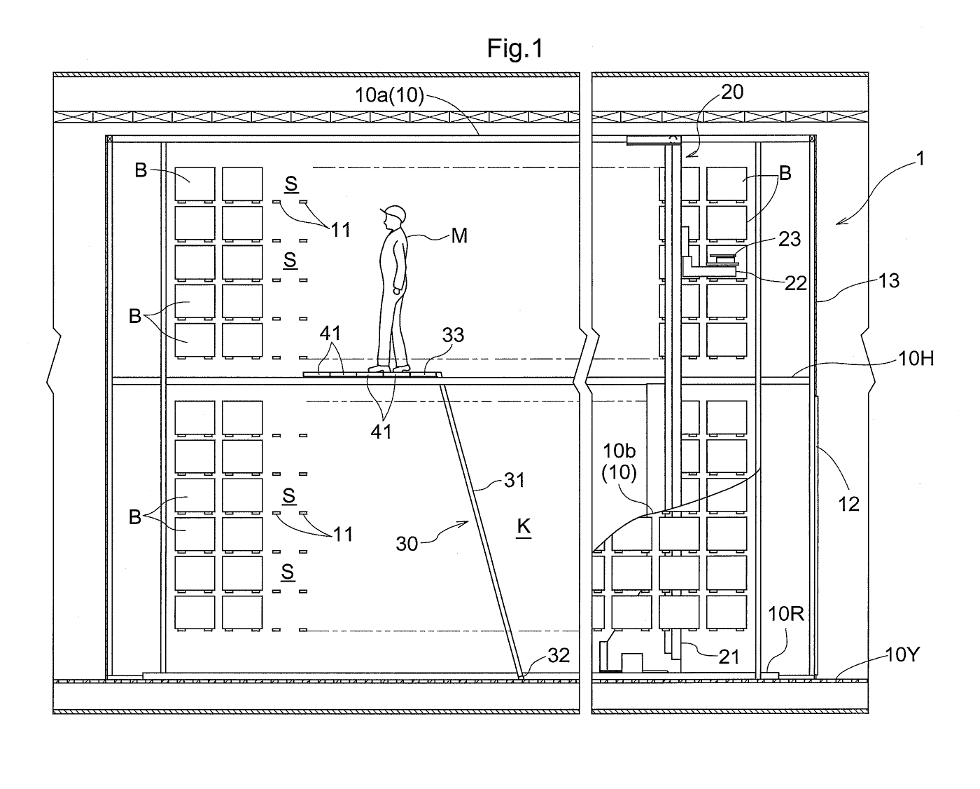

With reference to the drawings, a description will be given of a case where a ladder and a maintenance facility including the same according to an embodiment of the present invention are applied to a semiconductor substrate container warehouse. As shown in FIG. 1, a substrate container warehouse 1 is provided with a pair of storage racks 10 disposed such that the front sides thereof face each other. The storage racks 10 each include a plurality of vertically and horizontally arranged support members 11 for supporting substrate containers B as articles. A stacker crane 20 capable of travelling on a traveling rail 10R provided along the left-right direction of the storage racks 10 is provided in a space K formed between a pair of storage racks 10a and 10b. The stacker crane 20 includes a strut 21 extending along the vertical direction, an elevating member 22 capable of moving up and down along the strut, and a transfer device 23 that is provided on the elevating member 22 and is capable of transferring the substrate container B between a storage section and itself. The substrate container warehouse 1 is surrounded by a floor 10Y and a wall member 13, and an entrance 12 for allowing the entry of an operator M performing a maintenance work is provided at a portion of the wall member 13 toward one end of the stacker crane 20 in the traveling direction. In the present embodiment, a storage region S of the substrate container B that is supported by the support member 11 corresponds to the storage section.

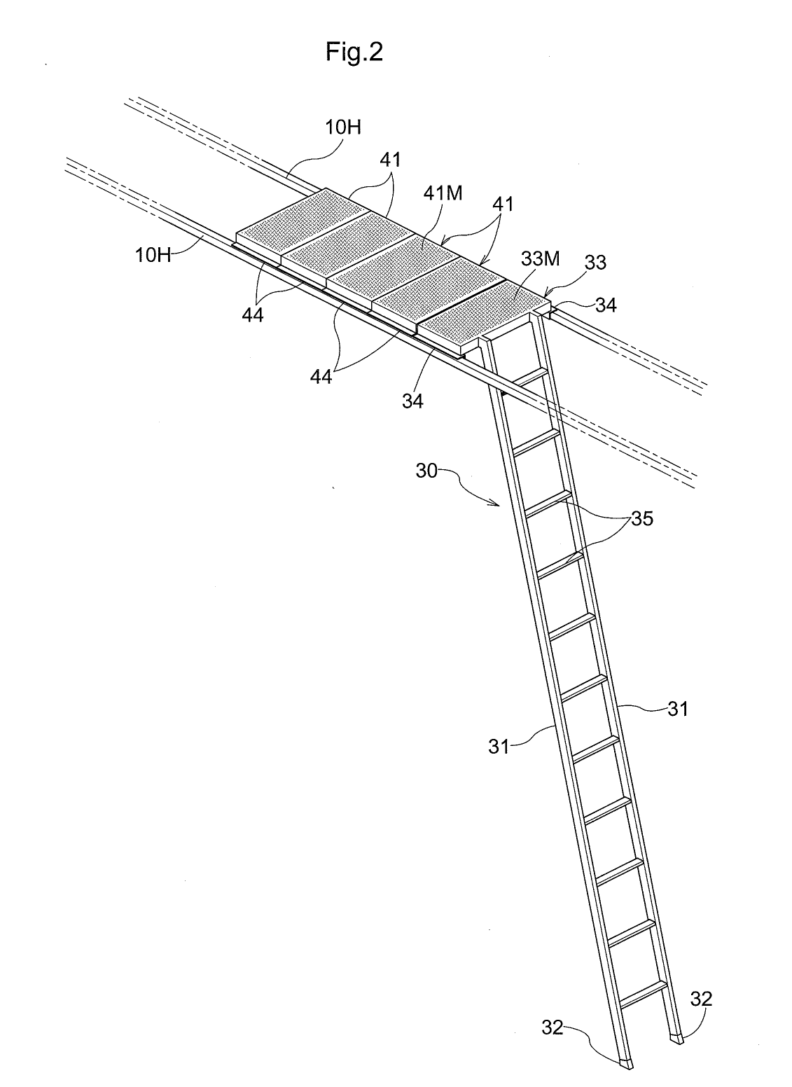

As shown in FIGS. 1 and 2, a pair of long horizontal members 10H are attached at a predetermined height position on the front sides of the pair of storage racks 10 so as to be oriented along the left-right direction of the storage racks 10. In the present embodiment, the pair of storage racks 10 correspond to the pair of structures, the space K formed therebetween corresponds to the installation space, and the horizontal members 10H respectively attached to the pair of storage racks 10 correspond to the pair of placement support portions.

When a substrate container B cannot be removed from such a substrate container warehouse 1 because of, for example, a failure of the stacker crane 20, the operator M needs to perform the removal of the substrate container B at a storage rack 10. In addition, when it is necessary to repair a support member 11, for example, the operator M needs to perform the operation at the front of the storage region S in which the support member 11 is to be repaired. At this time, it may be necessary to perform the operation for a storage region S located at a high place that cannot be reached by the operator M from the ground. In this case, the operator M carries in the ladder 30 from the outside of the substrate container warehouse 1 through the entrance 12 provided at the wall member 13, and installs the ladder 30 across a narrow installation space formed between the pair of storage racks 10. Then, the operator ascends and descends the ladder 30 to access the position where the desired storage region S is located.

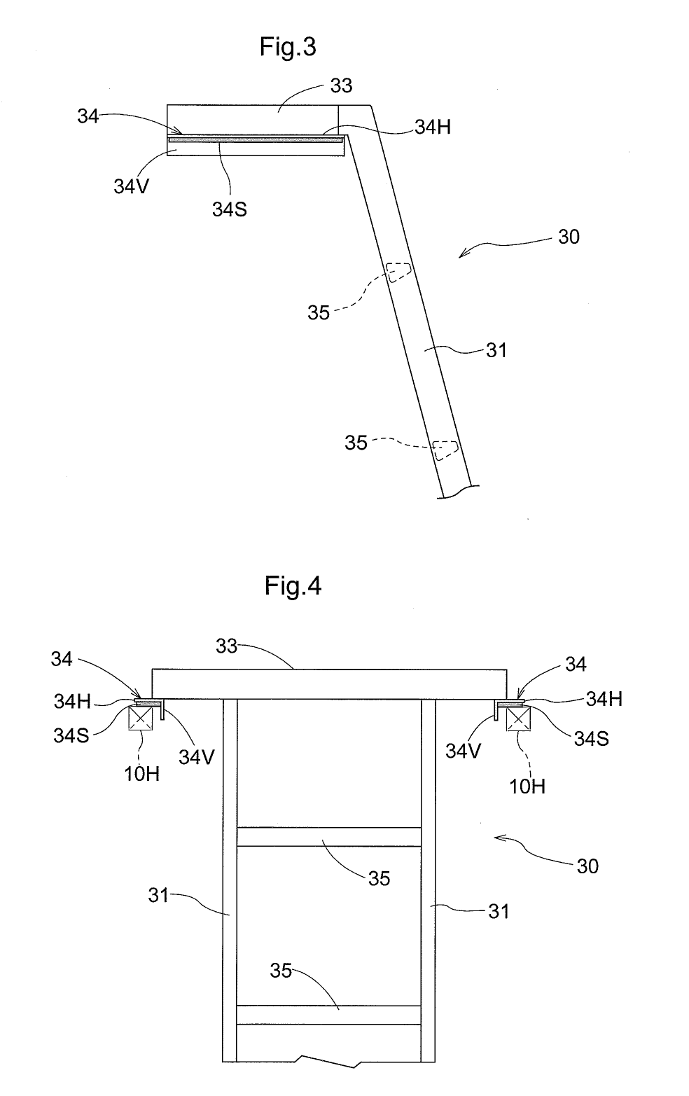

Here, a description will be given of the configuration of the ladder 30. As shown in FIG. 2, the ladder 30 includes a pair of longitudinal bars 31, and a plurality of lateral bars 35 spanning therebetween so as to be spaced apart in the longitudinal direction of the longitudinal bar 31. As shown in FIGS. 3 and 4, at the upper end of the pair of longitudinal bars 31, a step 33 that the operator M can ride on is provided between the pair of longitudinal bars 31 and over a set length extending outward of the outer side surfaces of the pair of longitudinal bars 31 in the direction of alignment (hereinafter referred to as “ladder width direction”). In the present embodiment, the step 33 corresponds to the flat portion.

A top surface 33M of the step 33 is formed flat. The step 33 and each of the pair of longitudinal bars 31 are fixed and connected in a state in which the angle formed between a direction orthogonal to a direction along which the top surface 33M of the step 33 extends and a direction along which the longitudinal direction of the longitudinal bar 31 extends is a predetermined angle within the range of 0 degrees to 45 degrees (preferably, 10 degrees to 20 degrees), as viewed in the ladder width direction. In addition, the step 33 is formed such that its length in a direction orthogonal to the ladder width direction is shorter than the distance between the outer side surfaces of the pair of longitudinal bars 31 in the ladder width direction, as viewed in the longitudinal direction of the pair of longitudinal bars 31.

On the back surface (the side on which the longitudinal bars 31 are located) of the step 33, locking members 34 each including a planar vertical member 34V and a planar horizontal portions 34H are provided on opposite end portions of the step 33 in the ladder width direction. Each vertical member 34V is a planar member positioned inward of an end portion of the step 33 in the ladder width direction and extending downwardly (in the longitudinal direction of the longitudinal bar 31). Each horizontal portion 34H is a planar portion protruding outwardly in the ladder width direction from the position at which the vertical member 34V is provided. Furthermore, a planar antislip portion 34S formed of rubber, urethane foam, or the like is provided on the bottom surface of each of a pair of the horizontal portions 34H. In the present embodiment, the horizontal portions 34H of the locking members 34 correspond to the protruding portions. Note that ground engaging foot portions 32 are provided at the lower end of the ladder 30 as shown in FIGS. 1 and 2. A plate-shaped member formed of rubber, urethane foam, or the like is attached to the back surface of each ground engaging foot portion 32. This prevents sliding movement of the ladder 30 between the floor 10Y and the ground engaging foot portion 32.

Next is a description of the horizontal members 10H as the placement support portions and a configuration in which the ladder 30 is supported by the horizontal members 10H. As shown in FIGS. 2 and 4, the horizontal members 10H are provided so as to be spaced apart by a distance that is longer than the distance between the outer side surfaces of the upper end portions of the pair of longitudinal bars 31 of the ladder 30 in the direction of alignment. In addition, the top surface of each of the pair of horizontal members 10H is formed flat. The amount of outward protrusion in the ladder width direction of the horizontal portions 34H attached to the step 33 of the ladder 30 is set such that the horizontal portions 34H overlap in plan view with the horizontal members 10H located at the respective corresponding positions when the ladder 30 is oriented such that the direction of alignment of the upper end portions of the longitudinal bars 31 coincide with the direction of alignment of the pair of horizontal members 10H.

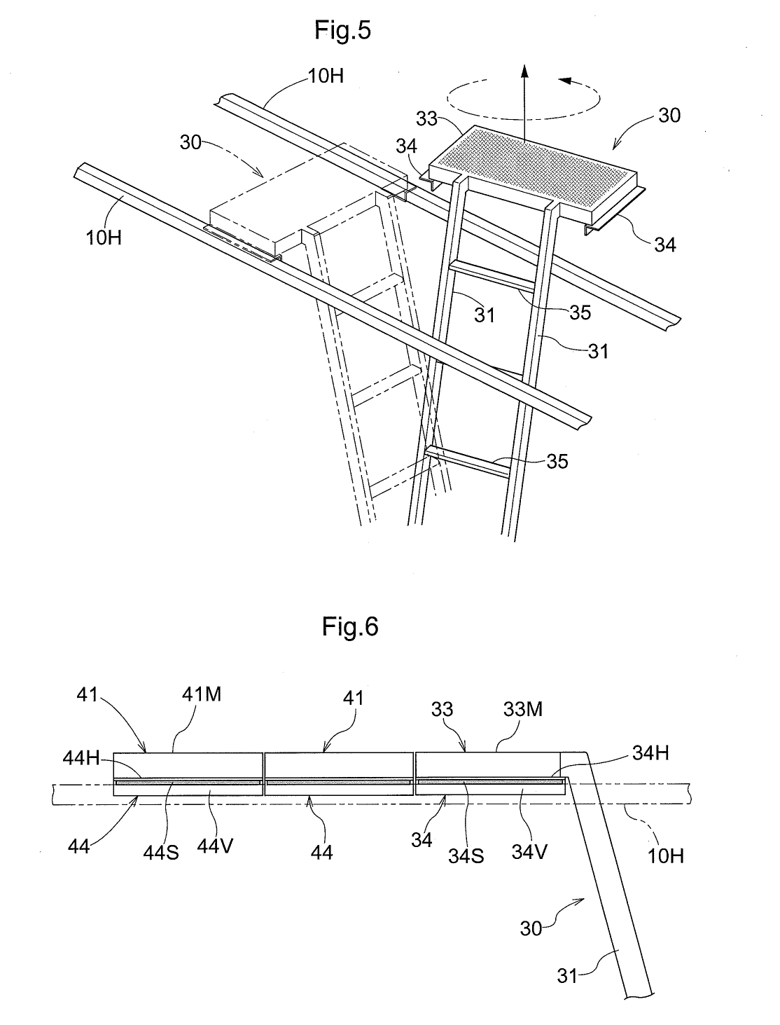

In installing the ladder 30 across the pair of horizontal members 10H, the operator M raises the entire ladder 30 at an angle at which the direction of alignment of the pair of longitudinal bars 31 and the direction of alignment of the pair of horizontal members 10H are orthogonal in plan view or at an angle close to the aforementioned angle, and upwardly inserts the step 33 provided at the upper end of the pair of longitudinal bars 31 between the pair of horizontal members 10H from below, as shown in FIG. 5. Subsequently, the operator M rotates the ladder 30 about an axis extending along the vertical direction in a state in which the step 33 is located at a higher position than the horizontal members 10H so as to orient the ladder 30 such that the direction of alignment of the upper end portions of the longitudinal bars coincides with the direction of alignment of the pair of placement support portions. Then, the operator M lowers the entire ladder 30, and thereby, the pair of horizontal portions 34H attached to the step 33 of the ladder 30 are received and supported from below by the respective corresponding ones of the pair of horizontal members 10H. As shown in FIG. 6, in a state in which the bottom surfaces of the pair of horizontal portions 34H are received and supported by the top surfaces of the pair of horizontal members 10H, the top surface 33M of the step 33 is oriented along a horizontal plane.

In order to form a work scaffold that is continuous with the step 33 provided at the upper end of the ladder 30 installed across the horizontal members 10H, the horizontal members 10H are configured such that a plurality of footboards 41 can be placed thereon. As shown in FIG. 6, each footboard 41 is formed such that its length in the left-right direction of the storage racks 10 is substantially the same as the length of the step 33 in the left-right direction of the storage racks 10. In addition, the footboard 41 is provided with a pair of locking members 44 as with the step 33. The locking members 44 include vertical members 44V positioned inward of end portions of the footboard 41 in the ladder width direction and extending downwardly, and horizontal portions 44H protruding outwardly in the ladder width direction from the positions at which the vertical members 44V are provided. Additionally, a planar antislip portion 44S formed of rubber, urethane foam, or the like is provided on the bottom surface of each of the horizontal portions 44H of the locking members 44.

In placing the footboards 41 on the pair of horizontal members 10H, for example, the footboards 41 are handed to the operator M who has ascended the ladder 30 to an intermediate portion thereof or the operator M who is on the step 33 by another operator who is located below. Then, the operator M places the footboards 41 so as to be aligned in the left-right direction of the storage racks such that the bottom surfaces of the pair of horizontal portions 44H are received and supported by the top surfaces of the horizontal members 10H. In other words, the footboards 41 having a length shorter than the length of the storage racks 10 in the left-right direction are configured to be capable of being placed on the pair of horizontal members 10H such that their bottom surfaces are received and supported by the top surfaces of the pair of horizontal members 10H.

The thickness of each footboard 41 in the vertical direction is set such that a top surface 41M of the footboard 41 is at the same height as the top surface 33M of the step 33 when the ladder 30 is installed across the pair of horizontal members 10H in a state in which the footboard 41 is supported by the pair of horizontal members 10H. Accordingly, in a state in which the footboard 41 is placed on the pair of horizontal members 10H, the top surface 41M of the footboard 41 is continuous with the top surface 33M of the step 33 of the ladder 30, making it possible to form a scaffold with good operability. Here, it is preferable that the top surface 33M of the step 33 and the top surface 41M of the footboard 41 are provided with antislip asperities.

### Other Embodiments

(1) In the above embodiment, a description is given of a configuration in which the ladder 30 is installed across a pair of horizontal members by using, as the placement support portions, horizontal members attached to the front sides of the respective corresponding ones of a pair of storage racks. However, it is sufficient that the placement support portions are spaced apart by a set distance that is longer than the distance between the outer side surfaces of the upper end portions of the pair of longitudinal bars in the direction of alignment and their top surfaces are at the same height. In other words, a groove portion drilled into the ground may be the narrow installation space, and the ground surfaces located on opposite sides of the groove portion may be the placement support portions. Thus, the ladder of the present invention can be installed across various kinds of placement support portions, other than the horizontal members attached to the front sides of the pair of storage racks. In addition, as described in the above embodiment, it is possible to use beams for supporting articles in the storage sections as the placement support portions, instead of separately attaching the horizontal members 10H as the placement support portions to the front sides of the storage racks 10.

(2) In the above embodiment, a description is given of a case where a ladder and the storage rack maintenance facility including the same are used for a semiconductor substrate container warehouse. However, such a ladder and the storage rack maintenance facility including the same are not limited to the use for a semiconductor substrate container warehouse, but can be used for various storage racks, including, for example, a storage rack including storage sections for storing articles supported on pallets.

(3) In the above embodiment, a description is given of a configuration in which the antislip portion 34S that restricts the relative movement between the protruding portion and the horizontal member along the horizontal direction is provided on the bottom surface of each horizontal portion 34H. However, the antislip portion is not limited to such a configuration. For example, it is possible to adopt a configuration in which the antislip portion is provided on the top surface of the horizontal member 10H, but not on the bottom surface of the horizontal portion 34H, or a configuration in which the antislip portion is provided on both the top surface of the horizontal member 10H and the bottom surface of the horizontal portion 34H. Although the antislip portion in the above embodiment is a plate-shaped member formed of rubber, urethane foam, or the like, the antislip portion may be configured as a plurality of dot-like antislip portions that are arranged in a linear or planar pattern, rather than as a plate-shaped member. Alternatively, protrusions and recesses that restrict the relative movement in the horizontal direction by engaging with each other may be formed as the antislip portions on the bottom surface of the horizontal portion 34H and the top surface of the horizontal member 10H.

(4) In the above embodiment, a description is given of a configuration in which a pair of protruding portions protruding outwardly on opposite sides in the direction of alignment of the pair of longitudinal bars are used as the planar horizontal portions 34H. However, the protruding portions are not limited to such a configuration, and may be configured as rod-shaped members, for example. In this case, it is preferable that a plurality of rod-shaped members are provided in a direction orthogonal to the direction of alignment of the pair of longitudinal bars 31.

(5) In the above embodiment, a description is given of a configuration including the ladder 30 and the footboards 41 as the storage rack maintenance facility. However, the storage rack maintenance facility may only include the ladder 30.

(6) The above embodiment illustrates a configuration in which the step 33 and the pair of longitudinal bars 31 are connected such that the direction orthogonal to the direction along which the top surface of the step 33 extends and the direction along which the longitudinal direction of the longitudinal bar 31 extends are inclined to each other. However, the configuration for connecting the step 33 and the pair of longitudinal bars 31 may be such that the direction orthogonal to the direction along which the top surface of the step 33 extends and the longitudinal direction of the longitudinal bar 31 are orthogonal to each other. In addition, the above embodiment illustrates a configuration in which, when the step 33 and the pair of longitudinal bars 31 are connected such that the direction orthogonal to the direction along which the top surface of the step 33 extends and the direction along which the longitudinal direction of the longitudinal bar 31 extends are inclined to each other, the angle formed by the direction orthogonal to the direction along which the top surface of the step 33 extends and the direction along which the longitudinal direction of the longitudinal bar 31 extends is set to a predetermined angle within the range of 0 degrees to 45 degrees (preferably, 10 degrees to 20 degrees). However, the angle formed by the direction orthogonal to the direction along which the top surface of the step 33 extends and the direction along which the longitudinal direction of the longitudinal bar 31 extends may be freely set (e.g., 45 degrees or more).

(7) In the above embodiment, each longitudinal bar 31 of the ladder 30 is formed by a single long member. However, the longitudinal bar 31 may be formed by using a plurality of members such that it can be projected and retracted.

The following is a brief description of a summary of the embodiment of the present invention described above.

A preferred aspect of the present invention provides a ladder configured to be portable to be installed across an installation space formed between a pair of structures, the ladder including:

a pair of longitudinal bars;

a plurality of lateral bars spanning between the pair of longitudinal bars, the lateral bars being provided so as to be spaced apart from each other along a longitudinal direction of the longitudinal bars; and

a pair of protruding portions, the protruding portions protruding outwardly on opposite sides in a direction of alignment of the pair of longitudinal bars at an upper end of the pair of longitudinal bars,

wherein the pair of structures are provided with a pair of placement support portions that are spaced apart by a set distance that is longer than a distance between outer side surface of upper end portions of the pair of longitudinal bars in the direction of alignment,

an amount of protrusion of the protruding portions is set such that the pair of protruding portions overlap in plan view with the placement support portions located at respective corresponding positions when the ladder is oriented such that a direction of alignment of the upper end portions of the longitudinal bars coincides with a direction of alignment of the pair of placement support portions, and

the ladder is configured to be installed across the installation space by the pair of placement support portions receiving and supporting respective corresponding ones of the pair of protruding portions from below. Note that “plan view” refers to a state viewed in a direction along the vertical direction. In addition, the expression “overlap in plan view” includes at least partially overlapping state.

With this configuration, after carrying the ladder from the outside of the installation space into the installation space, the operator can install the ladder across the installation space by a simple operation of positioning the upper end of the ladder above the placement support portions provided at the respectively corresponding ones of the pair of structures while supporting the lower end of the ladder, and lowering the ladder in a state in which the pair of protruding portions overlap in plan view with the placement support portions at the respectively corresponding positions. Then, the direction of alignment of the upper end portions of the longitudinal bars (i.e., the longitudinal direction of the lateral bars) of the ladder installed in the above-described manner coincides with the direction of alignment of the pair of placement support portions. Accordingly, the operator can ascend and descend the ladder in an orientation in which the operator is directly facing a direction along the longitudinal direction of the narrow installation space.

With an installation method in which the ladder is rested against one of the pair of structures, the space in which the ladder and the operator who ascends and descends the ladder are located is interposed between the pair of structures. Usually, the installation space formed between the pair of structures is narrow, and therefore, the space formed behind the operator when the operator is directly facing the ladder is restricted. In particular, when the ladder is installed so as to be inclined to the structure, it is difficult to secure a sufficient space behind the operator at the lower end of the ladder, making the operator's ascending and descending difficult. In contrast, the ladder having the above-described configuration is installed in the installation space in a state in which the direction of alignment of the longitudinal bars extends along the direction of alignment of the pair of structures, and therefore, there is no structure behind the operator even if the operator is directly facing the ladder. Accordingly, it is possible to secure a sufficient space behind the operator, facilitating the operator's ascending and descending. Thus, with the above-described configuration, it is possible to provide a ladder that allows the operator to readily ascend and descend even when placed in the narrow installation space, and that is also easy to install.

Here, according to an aspect, it is preferable that the ladder includes a flat portion that the operator can ride on, the flat portion being provided at the upper end of the pair of longitudinal bars, wherein the flat portion is configured such that a top surface of the flat portion is oriented along a horizontal plane in a state in which bottom surfaces of the pair of protruding portions are received and supported by top surfaces of the pair of placement support portions. With this configuration, after ascending the installed ladder, the operator can ride on the flat portion provided at the upper end of the pair of longitudinal bars. Since the top surface of the flat portion extends along the horizontal plane in a state in which the ladder is installed across the installation space, the operator can ride on the flat portion in a stable posture and perform operations and the like.

According to an aspect, it is preferable that the ladder further includes an antislip portion that restricts relative movement between the protruding portions and the placement support portions along a horizontal direction, the antislip portion being provided on either or both bottom surfaces of the pair of protruding portions and top surfaces of the pair of placement support portions. With this configuration, in a state in which the ladder is installed across the installation space, the relative movement between the pair of protruding portions and the pair of placement support portions respectively corresponding thereto is restricted in the direction extending along the horizontal direction. Accordingly, the installation position and the orientation of the ladder in the installation space cannot be easily changed when the ladder is installed across the installation space, and therefore, the operator can readily ascend and descend the ladder.

According to an aspect, it is preferable that a storage rack maintenance facility in which the ladder is installed includes: a pair of storage racks each including a plurality of vertically and horizontally arranged storage sections for storing articles, the storage racks being disposed such that front sides thereof face each other with the set distance therebetween; and a pair of long horizontal members, the horizontal members being provided at a predetermined height on the front sides of the storage racks, so as to be oriented along a left-right direction of the storage racks, wherein the ladder in installed using the pair of horizontal members as the pair of placement support portions and a space formed between the pair of storage racks as the installation space.

With this configuration, it is possible to install the ladder across the narrow installation space formed between the pair of storage racks in a state in which the direction of alignment of the longitudinal bars extends along the direction of alignment of the pair of storage racks. Accordingly, even when the operator is directly facing the ladder, the installation space extends behind the operator, but no storage rack extends therebehind. Therefore, a sufficient space (e.g., the extending installation space) can be secured behind the operator, facilitating the operator's ascending and descending. In addition, the provision of the pair of horizontal members over a predetermined range in the left-right direction of the respective corresponding ones of the pair of storage racks enables the ladder to be installed in the left-right direction of the storage racks at any position within the region where the horizontal members are located, thus contributing to good operability. Thus, with the above-described configuration, it is possible to provide a storage rack maintenance facility including a ladder that allows the operator to readily ascend and descend even when placed in a narrow installation space, that is easy to install, and that has also good operability.

According to one aspect, it is preferable that the storage rack maintenance facility further includes a footboard capable of being placed on the pair of horizontal members such that a bottom surface of the footboard is received and supported by top surfaces of the pair of horizontal members. The placement of the footboard on the horizontal members can provide, in addition to the flat portion at the upper end of the ladder, a work scaffold at the height at which the horizontal members are placed in the installation space. It is possible to adopt a configuration in which this footboard is formed such that its length in the left-right direction of the storage racks is a set length sufficient for the operator to ride thereon to perform an operation, and only one such footboard is placed on the horizontal members. Alternatively, it is possible to adopt a configuration in which the footboard is formed such that its length in the left-right direction of the storage racks is shorter than the above-described set length and a plurality of the footboards are placed on the horizontal members. In the case of placing a plurality of footboards on the horizontal members, a continuous scaffold can be provided by arranging the plurality of footboards so as to be in close contact with each other. It is also possible to arrange the plurality of footboards so as to be spaced apart from each other. Thus, the placement of the footboard on the horizontal members makes it possible to provide a storage rack maintenance facility that allows the formation of a scaffold with good operability.

According to one aspect, it is preferable that the storage rack maintenance facility further includes a flat portion that an operator can ride on, the flat portion being provided at the upper end of the pair of longitudinal bars, wherein the footboard has a thickness in a vertical direction such that a top surface of the footboard is at the same height as a top surface of the flat portion when the ladder is installed across the pair of horizontal members in a state in which the footboard is supported by the pair of horizontal members. With this configuration, when the footboard is installed across the pair of horizontal members, the top surface of the footboard can be made continuous with the flat portion of the ladder installed across the pair of horizontal members. Accordingly, it is possible to form a work scaffold extending continuously without any difference in height when the flat portion of the ladder and the footboard are made continuous and supported by the pair of horizontal members. As a result, it is possible to provide a storage rack maintenance facility that provides good operability for the operator.

1. A ladder configured to be portable to be installed across an installation space formed between a pair of structures, the ladder comprising:
a pair of longitudinal bars;
a plurality of lateral bars spanning between the pair of longitudinal bars, the lateral bars being provided so as to be spaced apart from each other along a longitudinal direction of the longitudinal bars; and
a pair of protruding portions, the protruding portions protruding outwardly on opposite sides in a direction of alignment of the pair of longitudinal bars at an upper end of the pair of longitudinal bars,
wherein the pair of structures are provided with a pair of placement support portions that are spaced apart by a set distance that is longer than a distance between outer side surface of upper end portions of the pair of longitudinal bars in the direction of alignment,
an amount of protrusion of the protruding portions is set such that the pair of protruding portions overlap in plan view with the placement support portions located at respective corresponding positions when the ladder is oriented such that a direction of alignment of the upper end portions of the longitudinal bars coincides with a direction of alignment of the pair of placement support portions, and
the ladder is configured to be installed across the installation space by the pair of placement support portions receiving and supporting respective corresponding ones of the pair of protruding portions from below.

2. The ladder according to claim 1, further comprising
a flat portion that the operator can ride on, the flat portion being provided at the upper end of the pair of longitudinal bars,
wherein the flat portion is configured such that a top surface of the flat portion is oriented along a horizontal plane in a state in which bottom surfaces of the pair of protruding portions are received and supported by top surfaces of the pair of placement support portions.

3. The ladder according to claim 1, further comprising
an antislip portion that restricts relative movement between the protruding portions and the placement support portions along a horizontal direction, the antislip portion being provided on either or both bottom surfaces of the pair of protruding portions and top surfaces of the pair of placement support portions.

4. The ladder according to claim 2, further comprising
an antislip portion that restricts relative movement between the protruding portions and the placement support portions along a horizontal direction, the antislip portion being provided on either or both bottom surfaces of the pair of protruding portions and top surfaces of the pair of placement support portions.

5. A storage rack maintenance facility in which the ladder according to claim 1 is installed, comprising:
a pair of storage racks each including a plurality of vertically and horizontally arranged storage sections for storing articles, the storage racks being disposed such that front sides thereof face each other with the set distance therebetween; and
a pair of long horizontal members, the horizontal members being provided at a predetermined height on the front sides of the storage racks, so as to be oriented along a left-right direction of the storage racks,
wherein the ladder in installed using the pair of horizontal members as the pair of placement support portions and a space formed between the pair of storage racks as the installation space.

6. A storage rack maintenance facility in which the ladder according to claim 2 is installed, comprising:
a pair of storage racks each including a plurality of vertically and horizontally arranged storage sections for storing articles, the storage racks being disposed such that front sides thereof face each other with the set distance therebetween; and
a pair of long horizontal members, the horizontal members being provided at a predetermined height on the front sides of the storage racks, so as to be oriented along a left-right direction of the storage racks,
wherein the ladder in installed using the pair of horizontal members as the pair of placement support portions and a space formed between the pair of storage racks as the installation space.

7. A storage rack maintenance facility in which the ladder according to claim 3 is installed, comprising:
a pair of storage racks each including a plurality of vertically and horizontally arranged storage sections for storing articles, the storage racks being disposed such that front sides thereof face each other with the set distance therebetween; and
a pair of long horizontal members, the horizontal members being provided at a predetermined height on the front sides of the storage racks, so as to be oriented along a left-right direction of the storage racks,
wherein the ladder in installed using the pair of horizontal members as the pair of placement support portions and a space formed between the pair of storage racks as the installation space.

8. A storage rack maintenance facility in which the ladder according to claim 4 is installed, comprising:
a pair of storage racks each including a plurality of vertically and horizontally arranged storage sections for storing articles, the storage racks being disposed such that front sides thereof face each other with the set distance therebetween; and
a pair of long horizontal members, the horizontal members being provided at a predetermined height on the front sides of the storage racks, so as to be oriented along a left-right direction of the storage racks,
wherein the ladder in installed using the pair of horizontal members as the pair of placement support portions and a space formed between the pair of storage racks as the installation space.

9. The storage rack maintenance facility according to claim 5, further comprising
a footboard capable of being placed on the pair of horizontal members such that a bottom surface of the footboard is received and supported by top surfaces of the pair of horizontal members.

10. The storage rack maintenance facility according to claim 6, further comprising
a footboard capable of being placed on the pair of horizontal members such that a bottom surface of the footboard is received and supported by top surfaces of the pair of horizontal members.

11. The storage rack maintenance facility according to claim 7, further comprising
a footboard capable of being placed on the pair of horizontal members such that a bottom surface of the footboard is received and supported by top surfaces of the pair of horizontal members.

12. The storage rack maintenance facility according to claim 8, further comprising
a footboard capable of being placed on the pair of horizontal members such that a bottom surface of the footboard is received and supported by top surfaces of the pair of horizontal members.

13. The storage rack maintenance facility according to claim 9, further comprising
a flat portion that an operator can ride on, the flat portion being provided at the upper end of the pair of longitudinal bars,
wherein the footboard has a thickness in a vertical direction such that a top surface of the footboard is at the same height as a top surface of the flat portion when the ladder is installed across the pair of horizontal members in a state in which the footboard is supported by the pair of horizontal members.

14. The storage rack maintenance facility according to claim 10, further comprising
a flat portion that an operator can ride on, the flat portion being provided at the upper end of the pair of longitudinal bars,
wherein the footboard has a thickness in a vertical direction such that a top surface of the footboard is at the same height as a top surface of the flat portion when the ladder is installed across the pair of horizontal members in a state in which the footboard is supported by the pair of horizontal members.

15. The storage rack maintenance facility according to claim 11, further comprising
a flat portion that an operator can ride on, the flat portion being provided at the upper end of the pair of longitudinal bars,
wherein the footboard has a thickness in a vertical direction such that a top surface of the footboard is at the same height as a top surface of the flat portion when the ladder is installed across the pair of horizontal members in a state in which the footboard is supported by the pair of horizontal members.

16. The storage rack maintenance facility according to claim 12, further comprising
a flat portion that an operator can ride on, the flat portion being provided at the upper end of the pair of longitudinal bars,
wherein the footboard has a thickness in a vertical direction such that a top surface of the footboard is at the same height as a top surface of the flat portion when the ladder is installed across the pair of horizontal members in a state in which the footboard is supported by the pair of horizontal members.
